(19) United States
(12) Patent Application Publication
(10) Pub. No.: US 2002/0150446 A1
(43) Pub. Date: Oct. 17, 2002

(54) Platform for stacking circular saw blades

(76) Inventors: Peter Lenard, Biberach (DE); Ernst Beck, Biberach (DE)

Correspondence Address: Clifford W. Browning, Woodard, Emhardt,, Naughton, Moriarty & McNett, Bank One Center/Tower, 111 Monument Circle, Ste 3700, Indianapolis, IN, 46204-5137, US

(21) Appl. No.: 10/161,496

(22) Filed: Jun. 3, 2002

Related U.S. Application Data
(63) Continuation of application No. PCT/EP01/11337, filed on Oct. 1, 2001.

(30) Foreign Application Priority Data
Oct. 13, 2000 (DE) 100 50 803.0

(51) Int. Cl. B65G 57/16

(52) U.S. Cl. 414/27; 414/908

(57) ABSTRACT

The platform (20) has a centrally disposed holding device (30) to which a mandrel (32) for centering a stack of saw blades (12) is normally fastened in an upright manner. Disposed on the said platform (20), at intervals from the central holding device (30), are at least two decentralised holding devices (34) to each of which a mandrel (36) can likewise be fastened for centering a stack of saw blades (12) in each case. All the mandrels (32, 36) are capable of being fastened to, and detached from, their holding devices (30, 34) independently of one another, and are interchangeable with one another.

The invention relates to a platform for stacking circular saw blades, the said platform having a holding device which is disposed centrally on the platform and to which a cental mandrel for centering a stack of saw blades is normally fastened in an upright manner.

Platforms of this kind, which are mostly in the form of load platforms on hand-barrows, are usually used to hold circular saw blades ready in stacks for the initial sharpening or the resharpening of their saw teeth, so that the said blades are delivered piece by piece to a machining apparatus and, after their teeth have been sharpened, are once again stacked on such a platform (DE-A-198 08 339).

The sharpening of saw teeth usually comprises a number of working operations, such as the grinding of the breast, back and flank faces of the teeth. Apparatuses which are suitable for this purpose may consist of a number of individual machines which are interlinked with one another by a robot and are capable of machining circular saw blades of different diameters and with different toothing systems in a fully automatic manner. In order to permit unmanned operation of such an apparatus over a fairly long space of time, for example a complete night shift, the working area of a robot which is intended for feeding the apparatus with circular saw blades and for removing machined blades has already been expanded in such a way that it extends to stations for a fairly large number of platforms each having a central mandrel for centering a stack of saw blades in each case. So that the platforms are interchangeable with one another and can thus be disposed within the working area of the robot in any desired sequence, is it usual for all the platforms to have the same dimensions, from which it follows that they must all be dimensioned in such a way that they are capable of receiving the largest circular saw blades which are encountered. This being the case, it has hitherto been accepted that only a fairly small portion of the stacking area available on a platform is used when the said area is occupied by a stack of circular saws of small diameter. Since, however, circular saw blades of small diameter generally require a shorter machining time than circular saw blades of larger diameter, unmanned operation of an apparatus for machining circular saw blades is possible over a certain space of time, for example a complete night shift, only if, the smaller the diameter of the circular saw blades mainly encountered, the more platforms with stacked circular saw blades are held ready at the apparatus.

In an apparatus for machining circular saw blades which is to be fed with stacked circular saw blades by means of a given number of platforms of the kind described, the object underlying the invention is to improve the prerequisites which enable unmanned operation to be maintained, substantially irrespective of the sizes of saw blade mainly encountered, over a certain space of time, for example a complete night shift.

This object is achieved, according to the invention, with the aid of a further development of the platform initially described, in which there are disposed on the said platform, at intervals from the central holding device, at least two decentralised holding devices to each of which a mandrel can likewise be fastened for centering a stack of saw blades in each case. This provides the possibility of selectively disposing on the platform a single stack of circular saw blades of large diameter or two or more stacks of medium or small diameter.

All the mandrels are preferably capable of being fastened to, and detached from, their holding devices independently of one another. The consequence of this is that the central holding device does not need to be occupied by a mandrel if a stack of circular saw blades is to be formed, in each case, on two or more mandrels which are each fastened to a decentralised holding device. These stacks can therefore utilise the space above the central holding device.

The fact that all the mandrels are interchangeable with one another is also expedient. However, this does not mean that all the mandrels need to be completely identical. It is sufficient if all the mandrels are in conformity with one another in those regions in which they interact with the holding devices. On the other hand, in the regions in which the mandrels extend through a central hole, in each case, in the stacked saw blades, the said mandrels expediently have a diameter which is adapted, with slight clearance, to the hole diameter of the stacked circular saw blades.

In any case, it is also advantageous if all the decentralised holding devices are disposed at equal intervals from the central holding device.

Two decentralised holding devices and the central holding device may be disposed side by side in a row. Under these circumstances, it is expedient if guide means for insertion into an apparatus for machining circular saw blades are constructed on the platform in such a way that they define a direction of insertion which extends in a manner normal to the row of holding devices. In an arrangement of this kind, a robot need only be capable of travelling along the aforesaid row in order to remove circular saw blades from the individual mandrels or, after machining, to stack them on the said mandrels again.

However, it is also possible for all the decentralised holding devices to each be disposed on a corner of an equilateral polygon, in the middle of which the central holding device is disposed.

Exemplified embodiments of the invention will be explained in greater detail below with the aid of diagrammatic drawings, in which:

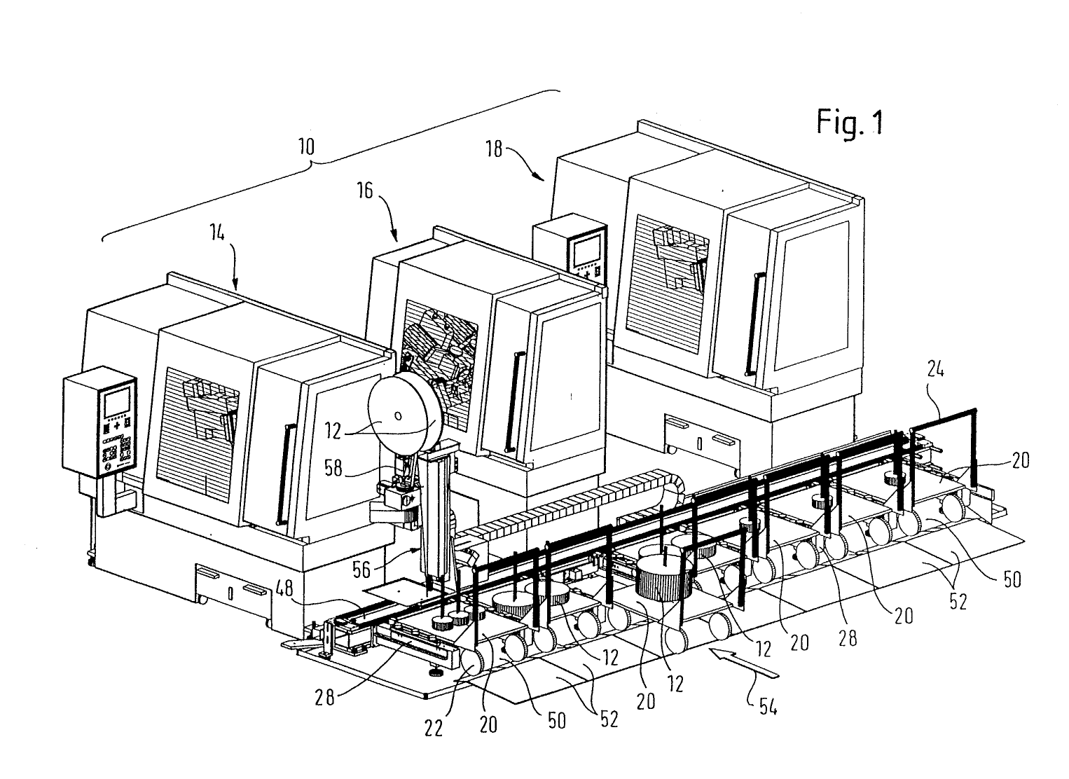

FIG. 1 shows, in an oblique view from above, a machining apparatus which is fed with circular saw blades by means of a number of platforms according to the invention;

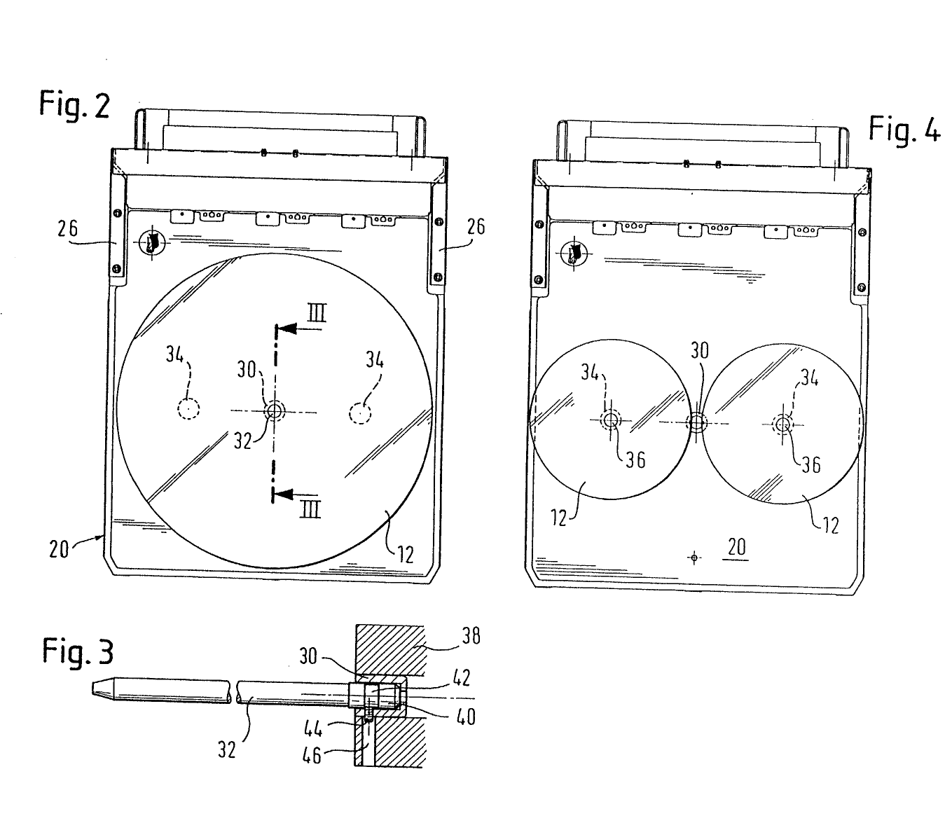

FIG. 2 shows a plan view of one of the platforms, which is set up for a stack of circular saw blades of large diameter;

FIG. 3 shows a section in the perpendicular plane III-III in FIG. 2;

FIG. 4 shows a plan view of another of the platforms represented in FIG. 1, which is set up for two stacks of circular saws of medium diameter;

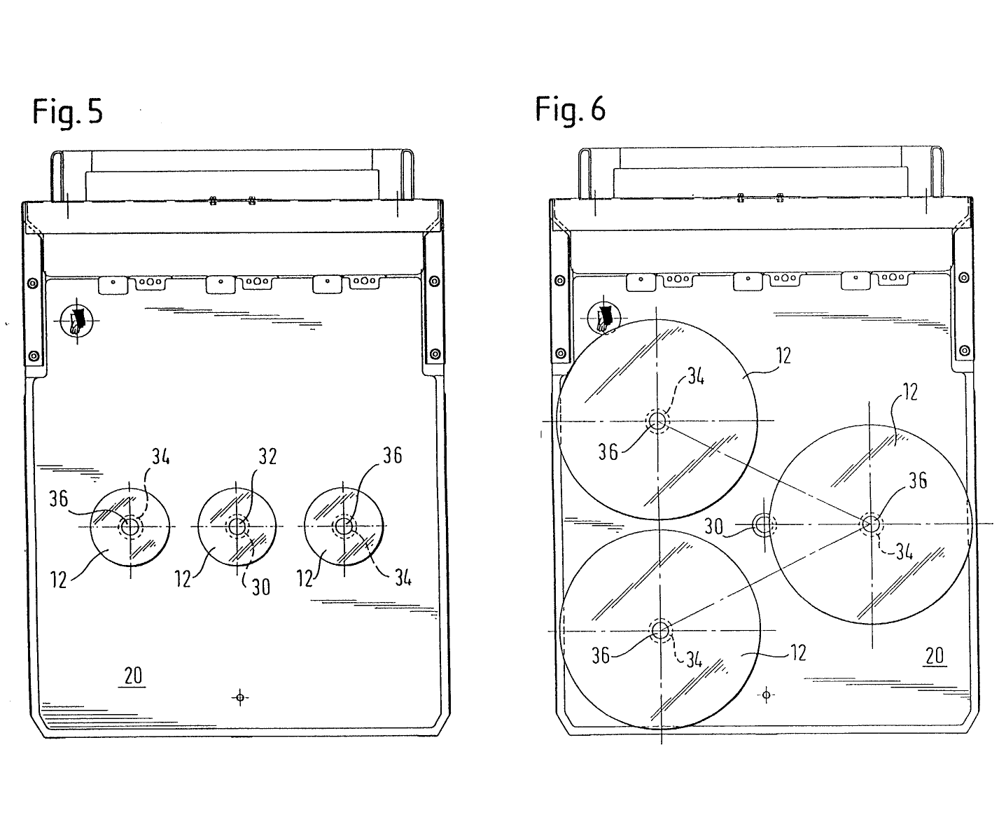

FIG. 5 shows a plan view of yet another of the platforms represented in FIG. 1, which is set up for three stacks of circular saws of small diameter; and

FIG. 6 shows a plan view of a platform in a modified form of embodiment, which is set up for three stacks of circular saws of medium diameter.

An apparatus 10 for machining carbide-tipped teeth on saw blades 12 is represented in FIG. 1. The apparatus 10 includes a machine 14 for grinding breast faces of the teeth, which faces are also described as “cutting faces”, a machine 16 for grinding back faces of the teeth, which faces are also described as “free faces”, and a machine 18 for simultaneously grinding two side faces of the teeth, which faces are also described as “tooth flanks”. In order to hold ready stacks of the circular saw blades 12 to be ground, which may have very different diameters, use is made of platforms 20 which, in the example represented, are each disposed on an undercarriage 22 of their own and can be moved manually by means of an upwardly projecting handle 24 fastened to them. All the platforms 20 associated with the apparatus 10 are of the same size and each have two longitudinal rims which are constructed as guide means 26 and by which the platform is guided and centred when it is inserted between two horizontal roller trains 28 in the manner represented.

Each of the platforms 20 has a central holding device 30 for a central mandrel 32 which extends perpendicularly upwards from the platform. Furthermore, each of the platforms 20 has at least two decentralised holding devices 34 which are disposed at equal intervals from the central holding device 30 and are each intended to receive a decentralised mandrel 36 when required. In the arrangement represented in FIG. 2, only the central holding device 30 is occupied by a mandrel 32; the two decentralised holding devices 34, which are indicated by broken lines in FIG. 2, are unoccupied, so that the space above them is clear for a stack of circular saw blades 12 of the largest diameter which can be machined by the apparatus 10.

In the arrangement according to FIG. 4, on the other hand, the central holding device 30 is not occupied by a mandrel, whereas the two decentralised holding devices 34, which are disposed as in FIG. 2, each carry a decentralised mandrel 36. These two decentralised mandrels 36 each centre a stack of circular saw blades 12 of medium diameter.

In contrast to this, in the arrangement according to FIG. 5, all the holding devices 30 and 34 are each occupied by a mandrel; the central holding device 30 therefore carries the central mandrel 32, while the two decentralised holding devices 34 each carry a decentralised mandrel 36. These mandrels 32 and 36, of which there are three in all, each carry a stack of circular saw blades 12 of small diameter.

In the examples represented, the decentralised holding devices 34 are completely identical to the central holding device 30, for which reason it is sufficient for only the central holding device 30 to be represented in perpendicular section in FIG. 3. The holding devices 30 and 34 are each formed by a bush made of hardened steel and having ground inner and outer cylindrical superficies, and are each fastened in, for example forced into, a tubular base 38 in the appertaining platform 20. The mandrels 32 and 36 likewise consist of hardened steel and each have a substantially cylindrical foot 40 which fits, with a push fit and therefore substantially without any clearance, into each of the holding devices 30 and 34, and has an annular groove 42. Screwed radially into each of the holding devices 30 and 34 is a clamping screw 44 which, in the tightened condition, engages in the annular groove 42 in the appertaining mandrel 32 or 36 in such a way that the said mandrel is secured against being pulled out in an unintended manner. Each of the tubular bases 38 has a radial bore 46 through which the appertaining clamping screw 44 is accessible with the aid of a key, for example an internal hexagon key.

The three machines 14, 16 and 18 are disposed in a row, parallel to, and on one side of, a longitudinal rail 48, on the opposite side of which a number of stations 50—seven in the example represented—for one of the platforms 20 in each case are provided between each pair of roller trains 28. Disposed in front of each station 50 is a ramp 52 which facilitates the pushing of one of the platforms 20 provided with an undercarriage 22 onto the station in question in the direction of insertion 54 indicated by an arrow.

There can travel along the longitudinal rail 48 a robot 56 which carries a double gripper arrangement 58 and is capable, with the aid of the latter, of removing a machined circular saw blade 12 from any of the machines 14, 16 and 18 and then pivoting it by 1800, inserting in the same machine a saw blade which is to be machined, and finally delivering the machined saw blade to another of the machines or depositing it on one of the platforms 20, depending upon whether further machining of the said saw blade is necessary or not. The gripper arrangement 58 may, for example, be designed in accordance with DE-A-100 05 378.

The platform 20 represented in FIG. 6 differs from those represented in FIGS. 1, 2, 4 and 5 through the fact that three decentralised holding devices 34 are disposed around the central holding device 30 at equal intervals. It is therefore possible to selectively accommodate on this platform up to three stacks of circular saw blades 12 of medium diameter instead of a single stack of circular saw blades of large diameter.

Alternatively, four or more decentralised holding devices 34 may be disposed around the central holding device 30, each at a corner of a regular polygon.

1. Platform for stacking circular saw blades (12), the said platform having a holding device (30) which is disposed centrally on the platform (20) and to which a mandrel (32) for centering a stack of saw blades (12) is normally fastened in an upright manner,
characterised in that there are disposed on the said platform (20), at intervals from the central holding device (30), at least two decentralised holding devices (34) to each of which a mandrel (36) can likewise be fastened for centering a stack of saw blades (12) in each case.

2. Platform according to claim 1,
characterised in that all the mandrels (32, 36) are capable of being fastened to, and detached from, their holding devices (30, 34) independently of one another.

3. Platform according to claim 2,
characterised in that all the mandrels (32, 36) are interchangeable with one another.

4. Platform according to one of claims 1 to 3,
characterised in that all the decentralised holding devices (34) are disposed at equal intervals from the central holding device (30).

5. Platform according to claim 4,
characterised in that two decentralised holding devices (34) and the central holding device (30) are disposed side by side in a row.

6. Platform according to claim 5,
characterised in that guide means (26) for insertion into an apparatus (10) for machining circular saw blades (12) are constructed on the platform (20) in such a way that they define a direction of insertion (54) which extends in a manner normal to the row of holding devices (30, 34).

7. Platform according to one of claims 1 to 6,
characterised in that all the decentralised holding devices (30, 34) are each disposed at a corner of an equilateral polygon, in the middle region of which the central holding device (30) is disposed.
